(19) United States
(12) Patent Application Publication
(10) Pub. No.: US 2003/0026582 A1
(43) Pub. Date: Feb. 6, 2003

(54) Variable optical attenuator and method for improved linearity of optical signal attenuation versus actuation signal

(76) Inventors: Sebastiaan Roderick IN' T Hout, San Jose, CA (US); Vladimir Vaganov, Los Gatos, CA (US)

Correspondence Address: PATRICK REILLY, 1215 BOURDEAUX, SUNNYVALE, CA, 94089, US

(21) Appl. No.: 09/922,315

(22) Filed: Aug. 2, 2001

(51) Int. Cl. G02B 6/26

(52) U.S. Cl. 385/140; 385/18; 385/31

(57) ABSTRACT

A variable optical attenuator, or VOA, and method of operation is provided. The operational method increases the linearity of the optical signal attenuation versus an applied actuator actuation signal and decreases the attenuation loss sensitivity to actuation signal noise and actuation signal uncertainty. A preferred embodiment has a light emitting waveguide and optionally an output waveguide, a focusing system, a mirror having a reflecting surface, and a mirror actuator. The mirror is operatively connected with a suspension element that returns the mirror to a highest attenuation, or zero actuation, position when the actuator fails to supply a minimal force to the mirror. The preferred embodiment provides better optical attenuation accuracy and enables reductions in both the complexity and cost of control circuitry of the VOA. The present invention may be implemented as a micro-electro-mechanical system, or MEMS, comprising a microstructure having a mirror and a collimator, where the MEMS is coupled to one or more optical fibers.

### FIELD OF THE INVENTION

The present invention relates generally to the use and design of variable optical attenuators. The present invention more particularly relates to variable optical attenuators that include a movable mirror.

### BACKGROUND OF THE INVENTION

The most common uses of variable optical attenuators, or VOA, within an optical transmission network include the employment of a VOA to controllably attenuate the intensity of light beam transmitted as received from a first optical fiber or waveguide and reflected into a second optical fiber or waveguide. Prior art methods present an optical signal transmission of a light beam as radiated from an end-face of an input optical fiber and thereafter collimated to form a light beam by means of a collimating and focusing element, such as an optical lens. The prior art systems typically reflect the collimated light beam off of a moveable mirror that is facing the lens, and then focus the reflected collimated light beam via the lens onto an end-face of a output waveguide, such as an optical fiber. Optical attenuation is often achieved by mis-aiming the focal point of the light beam away from a core of an output optical fiber. The degree of mis-aiming is related to the distance between a center of a core of the optical fiber and a location of a central focus point of the reflected light beam on the end-face of the output fiber. This distance, or ΔX, is determined by a tilt position of the mirror with respect to the lens.

The invention of Robinson, as disclosed in U.S. Pat. No. 6,137,941, (Oct. 24 2000) teaches that a digital micromirror device presents a plurality of discrete attenuation positions by pivoting a micromirror from one pre-set angular position to another. The optical loss, when expressed in decibels, induced by this prior art mis-aiming technique is approximately proportional to the square of the spatial/lateral misalignment of the central focus point of the reflected collimated light beam as reflected onto the end-face of the output fiber relative to a center of the core of the output fiber. This spatial misalignment, in turn, is approximately proportional to the tilt position of the mirror with respect to the collimating system, such as a lens. The optical losses, as combined in decibels metrics are approximately proportional to the square of the tilt position of the mirror with respect to the lens.

VOA prior art systems that include movable mirrors, such as semiconductor devices, electro-mechanical systems, or micro-electro-mechanical systems, or MEMS, generally have highly non-linear relationships between actuation signals and optical attenuation,. For example, VOA's implementing the often used prior art method of tilt adjustment by means of an electrostatic actuation of a MEMS mirror exhibit a more than squarely proportional relationship between mirror tilt angles and an applied actuation voltage.

Therefore, the overall VOA optical loss of the prior art, being a multiplicative combination of these two non-linear effects, becomes a highly non-linear function of the MEMS mirror actuation signal.

More particularly, the prior art VOA designs that reflect a light beam into an optical fiber define an initial and unpowered initial position that minimizes the distance ΔX, where ΔX is defined as the distance between (1) the center of the core of the fiber as presented on an end-face of the fiber and (2) the focus point of the reflected light beam onto the end-face. The prior art thereby establishes an initial position of the mirror that minimizes optical attenuation, or optical loss, of the transmission of the light beam within the VOA when the actuation signal is below a threshold level or at zero. The magnitude of the optical attenuation, or loss, of the light beam is roughly directly approximate to ΔX squared.

Referring now to the prior art VOA example of FIG. 1A, the magnitude of ΔX is roughly directly proportional to the magnitude of an angle θ, where the angle θ is defined as the angle formed by the intersection of a plane L and a plan P, where plane L is perpendicular to an optical axis B of the focusing lens, and the plane P is parallel to the reflecting surface of the mirror. In the prior art the angle θ is near zero or equal to zero at the initial position of the mirror. The corresponding optical loss is of the prior art VOA is therefore at a minimum or near a minimum optical loss. The value of the angle θ is equal to the initial position of angle θ plus or minus a value of an angle ε′, where the angle ε is defined as the angular displacement of the angle θ caused by the actuator of the VOA. In the prior art the initial angle θ is approximately zero, i.e. the reflecting surface is substantially parallel with the plane L of the lens at zero actuation. In the prior art where a voltage input serves as an actuation signal, the magnitude of the angle ε is roughly proportional to the magnitude of the voltage actuation signal raised to the exponential power in the range of 2.0 to 2.5. As the magnitude optical loss is roughly proportional to the square of the magnitude of ΔX, and ΔX is directly proportional to the angle θ, and the angle θ is equal or approximately equal to the angle ε, the value of the optical loss is roughly proportional to the magnitude of the voltage actuation signal raised to the exponential power in the range of 4 to 5.

This highly non-linear behavior of actuation signal magnitude to optical loss magnitude of the prior art has the disadvantage of increasing the complexity of the performance of optical attenuation delivered by the VOA and consequently increasing the cost and complexity of the necessary VOA active control circuitry. This undesirable complexity of the prior art is especially significant at higher loss set points, i.e. where the steeper part of the optical loss versus actuation transduction curve resides. The prior art techniques and systems pose severe demands on the accuracy of the applied actuation signal as required to produce a stable optical attenuation of the VOA. As a result, prior art systems require either more accurate, i.e. more expensive, control or actuation circuitry and components, or deliver an inferior performance at higher optical loss set points because of reduced accuracy of attenuation.

In another aspect of prior art VOA systems and methods of operations, the prior art VOA systems provide a plurality of discrete tilt positions of the mirror. Each unique discrete pivot position imposes a pre-determined degree of attenuation of a light beam that is transmitted from a light emitting channel and to a light receiving waveguide, or output waveguide. The prior art therefore limits the attenuation settings to a plurality of pre-established positions.

There is, therefore, a long felt need to provide VOA systems and methods of operation that increase the linearity of the relationship between the optical loss of the VOA and an actuation signal. There exists an additional long felt need to provide a VOA and method of VOA operation that delivers increased optical attenuation via less costly and less complex control or actuation components or circuitry. There further exists a long felt need to provide a VOA and a method of VOA operation that positions or orients a reflecting surface selectably within a continuous range of motion rather than within a plurality of discrete positions.

### OBJECTS OF THE INVENTION

It is an object of the present invention to provide a method and apparatus that improves the linearity between an electrical actuation signal and a resulting attenuation of an optical signal by a VOA.

It is an object of certain preferred embodiments of the present invention to provide a method and apparatus that includes and enables an electro-mechanical device to improve the linearity between an actuation signal and a resulting attenuation of an optical signal by a VOA.

It is an object of certain alternate preferred embodiments of the present invention to provide a method and apparatus that includes and enables an electro-mechanical semiconductor device that is useful to improve the linearity between an actuation signal and a resulting attenuation of an optical signal by a VOA.

It is an object of certain further alternate preferred embodiments of the present invention to provide a method and apparatus that includes and enables a micro-electro-mechanical system, or MEMS, that is useful to improve the linearity between an actuation signal and a resulting attenuation of an optical signal by a VOA.

It is an object of certain other preferred embodiments of the present invention to provide a method and an apparatus that provides an improved optical attenuation resolution along an optical attenuation range of a VOA.

It is an object of certain further alternate preferred embodiments of the present invention to provide a method and an apparatus that includes and uses a less complex optical attenuation control circuitry within a VOA.

It is an object of certain yet alternate preferred embodiments of the present invention to provide a method and an apparatus that provides a continuous range of mirror tilt positions within a continuous range of movement of a reflecting surface of a VOA, where the continuous range extends from a zero actuation position of maximum attenuation to a position of minimum or near minimum attenuation.

### SUMMARY OF THE INVENTION

According to the method of the present invention, a variable optical attenuator device, or VOA, is provided for controllably transmitting light beam, or a light beam, from an input light channel and into at least one output optical waveguide. A preferred embodiment of the present invention includes a light beam emitting input light channel,, a light collimating and focusing element, a mirror having a light beam reflecting surface, an output waveguide, a restoring element and a mirror actuator. The input light channel may be a waveguide, an optical fiber, or another suitable light transmission means known in the art.

In the preferred embodiment, the collimating and focusing element may be a lens, such as an optical lens, a variable focus lens, a lens system or a GRIN lens. The position of the mirror is referenced to an angle, where the angle θ is defined as the angle found between (1) a lens plane that is perpendicular to an optical axis of the collimating and focusing element and (2) a mirror plane that is parallel to a reflecting surface of the mirror. The mirror is oriented relative to lens plane L at an initial θ, or θi, when the actuator delivers zero force, or a force below a certain minimum. The mirror resides at a zero actuation position when θ equals θi. The preferred embodiment provides a maximum attenuation to an optical signal passing through the VOA when the mirror is at the zero actuation position. When the actuator applies force above a minimum level of force to the mirror, the mirror moves or rotates towards an orientation wherein the mirror plane is parallel to the lens plane. At the position of planarity between the lens plane and the mirror plane, the VOA provides a minimum attenuation of the optical signal. The angular displacement of the mirror from the zero actuation position, where θ equals θi, as imposed by the actuator is defined as ε. The angle θ is therefore equal to the initial θ value, or θi, minus the angle ε. As ε increases, the angle θ decreases, the mirror plane becomes more parallel to the lens plane, and the VOA approaches a minimum optical signal attenuation state.

The collimating and focusing element, or collimating element, may be a collimating and focusing lens or another suitable light beam collimating and focusing device or system known in the art. The light channel may be a waveguide, such as an optical fiber, or another suitable light beam or light beam channel or transmission means known in the art. The mirror actuator, or actuator moves the mirror from an initial θ, or θi, and the reflecting surface to vary the magnitude of the angle. The actuator may be directly or indirectly mechanically coupled with the mirror or the reflecting surface, or the actuator may use electrical or magnetic forces to actuate the mirror or the reflecting surface or other suitable actuation means or methods known in the art. Additionally or alternatively, the actuator may be operatively connected to the mirror or reflecting surface by or through two or more suitable intermediate operative components, forces, energies or media known in the art. An actuation signal, or control signal, directs the actuator to adjust the orientation of the reflecting surface in relationship to the lens in a non-linear proportion to the value or magnitude of the actuation signal. The actuation signal may be, or include, electrical power, electrical voltage, electrical current, heat, mechanical pressure, hydraulic pressure, pneumatic pressure or another suitable actuation signal medium or substance, in singularity or combination, known in the art. The actuator may be selected from the group consisting of an electro-static actuator, a piezo-electric actuator, a thermo-mechanical actuator, an electromagnetic actuator, and a polymer actuator, or other suitable actuators known in the art. A polymer actuator may be selected from the group including an electro-active polymer actuator, an optical-active polymer, a chemically active polymer actuator, a magneto-active polymer actuator, an acousto-active polymer actuator and a thermally active polymer actuator, or other suitable polymer actuators known in the art.

In certain preferred embodiments of the present invention the light beam emitting light channel is a light emitting optical fiber and transmits a light beam to the reflecting surface and may optionally, in various alternate preferred embodiments of the present invention, transmit the light beam through the collimating and focusing element en route to the reflecting surface. The mirror is initially positioned at a zero actuation position from where the mirror provides a pre-set maximal optical loss, for example an optical loss of 30 decibels, in a transmission of the light beam from the emitting optic fiber and to a target area of the output waveguide. The pre-set maximal loss may be selected in any particular embodiment according to a set of specifications, design requirements, performance requirements, manufacturing capabilities and technical capabilities of a VOA designer, user or manufacturer. The light beam reflects from the reflecting surface, is then focused by the collimating element and transmits onto the target area.

Where the output waveguide is an optical waveguide having an endface position to receive the reflected and focused light beam, the value of the optical loss as transmitted through the VOA is roughly proportionally related to the square of a distance ΔX, where ΔX is defined as the distance between (1) a center of a light transmitting core of the fiber as made accessible in cross-section on the end-face of the fiber and (2) a central focus point of the reflected light beam onto the end-face.

The value of the distance angle ΔX is roughly directly proportional to the value of the mirror, where the instantaneous value of the angle θ is equal to the zero actuation value of the angle θ minus an instantaneous value of an angle ε. The value of the angle ε the angle ε is defined as the angular displacement of the angle θ caused by the actuator of the present invention. The value of the angle s is roughly or exactly directly proportional to the value of the actuation signal raised to the exponential power in the range of 2.0 to 2.5. The value of the optical loss of the preferred embodiment of the present invention is therefore roughly directly proportional to the squared result of a subtraction of (1) a first value, the first value being a value that is non-linearly proportional to a magnitude of the actuation signal from (2) the value of θ at zero actuation. In the preferred embodiment the first value is or approximately proportional to a magnitude of the actuation signal raised to the exponential value in the range of 2.0 to 2.5.

In the preferred embodiment the initial value of θ is significantly large to create a useful attenuation operating range that presents an improved linearity between the value of the actuation signal and the optical loss of the invented VOA. The relationship between the optical loss and the value of the actuation signal presents a lower maximum sensitivity to actuation signal noise and uncertainty than does the prior art relationships of optical loss and actuation signal value.

Certain alternate preferred embodiments of the present invention comprise a light beam emitting optical fiber that reflects an attenuated light beam back into itself by reflection off of the mirror. In preferred embodiments of this type the target area is located on a same end-face of the light emitting optical fiber from which the light beam is emitted.

58. An alternate preferred embodiment of the method of the present invention includes a MEMS, or device, that includes a reflective surface for receiving and reflecting an incident optical signal beam, and at least one actuator operatively connected with the reflective surface for controlling the angular position of the reflective surface relative to the incident optical signal beam. The reflective surface may be flat, convex or concave. Certain preferred embodiments of the present invention that comprise a MEMS device may be integrated on a single substrate.

Certain alternate preferred embodiments of the present invention further comprise more than one input and/or more than one output waveguide. The purpose of the present invention is still accomplished as long as the incident light beam or a light beam emitting from at least one of the input waveguides is coupled to at least one of the output waveguides with variable efficiency or intensity.

Certain still alternate preferred embodiments of the present invention further comprise an actuator that is selected from the group consisting of an electro-static actuator, a piezo-electric actuator, a thermo-mechanical actuator, an electromagnetic actuator, and a polymer actuator, in singularity or in combination. The polymer actuator may be selected from the group consisting of an electro-active polymer actuator, an optical-active polymer, a chemically active polymer actuator, a magneto-active polymer actuator, an acousto-active polymer actuator and a thermally active polymer actuator, in singularity or in combination.

The actuator may, in certain further alternate preferred embodiments of the method of the present invention, respond to, either directly or indirectly, an applied actuation signal. The actuation signal may comprise electrical current, electrical voltage, electrical power, heat, a magnetic field, magnetic beam, or another suitable actuation signal media, substance or beam known in the art. The actuator may also, in certain still alternate preferred embodiments of the method of the present invention, in accordance with, or as a result of, the application or operative coupling of two or more simultaneously, or approximately simultaneously, transmitted or received actuation signals.

In the preferred embodiment, the initial position of the mirror of the VOA is intentionally misaligned angularly with respect to the lens, such as to obtain a non-zero tilt at zero actuation, where the angle θ is not equal to zero. This zero actuation location of the mirror at a stipulated initial position, or zero actuation position, will result in non-zero optical losses of an optical signal as the optical signal simultaneously transmits through the VOA. Specifically, the mirror may be misaligned such that the light beam attenuation at zero actuation equals the maximum required or desired loss according to a particular specification of the VOA. For example, a 30 decibel, or dB, attenuation is stipulated in an exemplary context of the placement of the preferred embodiment. This alternate method of the present invention as particularly actualized in the preferred embodiment comprises a control of the actuation of the mirror by a dynamic technique wherein the mirror tilts from the initial position, or the zero actuation position, and toward perfect alignment, i.e. a minimum attenuation position, with the lens as an actuation signal is applied to the actuator. When the mirror achieves the minimum attenuation position, the mirror is oriented with respect to the lens and the input waveguide, or light emitting waveguide, such that a minimum attenuation of the light beam, beam or signal is imposed by the VOA.

In certain still alternate preferred embodiments of the method of the present invention the collimating and focusing element may be a lens, a variable focus lens, an optical lens, a system of lenses, or a GRIN lens.

The method of the present invention as actualized in the preferred embodiment results in an increased linearization of the relationship between the VOA's optical beam attenuation versus actuation voltage transduction curve. In particular, the relationships created (1) between the tilt angle of the mirror versus optical signal attenuation, in dB, and (2) between the voltage applied as an actuation signal to the actuator of the preferred embodiment versus the tilt angle of the mirror, mathematically relate to form a partially compensating and linearizing relationship between the voltage as applied to the actuator versus the corresponding optical attenuation in dB of the VOA. The preferred embodiment has an electrostatically actuated mirror and presents an applied actuator voltage versus optical attenuation transduction curve that is highly linearized. The improved linearization of the relationship created between the applied actuator voltage and the optical attenuation of the preferred embodiment enables the preferred embodiment to provide better optical attenuation resolution within a certain range of attenuation. This improvement in the linearization of the relationship created between the applied actuator voltage and the optical attenuation of the preferred embodiment further enables the inclusion of less complex control or actuation components or circuitry, and thus enables the selection of less expensive actuator or control components or circuitry within the preferred embodiment.

Other objects, features, and advantages of the present invention will be apparent from the accompanying drawings and from the detailed description which follow below.

### BRIEF DESCRIPTION OF THE DRAWINGS

The present invention is illustrated by way of example and not limitation in the figures of the accompanying drawings, in which like references indicate similar elements, and in which:

FIG. 1A is a prior art example of a VOA having a mirror.

FIG. 1B is a preferred embodiment of the method of the present invention having a VOA with a mirror of the VOA in a zero actuation position and thereby providing a stipulated maximum attenuation.

FIG. 1C is a preferred embodiment of the method of the present invention of FIG. 1B having a VOA with a mirror of the VOA in a middle actuation position and thereby providing a stipulated attenuation below the maximum attenuation.

FIG. 1D is the VOA of FIG. 1B wherein the mirror of FIG. 1B is positioned to maximally transmit light beam from a first waveguide of FIG. 1B and into a second waveguide of FIG. 1B.

FIG. 1E is an alternate preferred embodiment of the present invention wherein a light emitting optical fiber reflects light off of a reflecting surface and accepts a reflected light beam back into itself.

FIG. 2 is a graphical representation of optical losses of a transmission of a light beam within an optical fiber VOA as a function of the amount of misalignment, or ΔX of the light beam focus position with respect to the center of the core of the output fiber.

FIG. 3 is a graphical representation of actuation tilt, or a, as a function of actuation voltage for an electrostatically actuated tilting mirror of the prior art VOA of FIG. 2.

FIG. 4 is a graphical representation of a total tilt, or θ, of the reflective surface with respect to a collimating and focusing element as a function of actuation tilt for a prior art VOA.

FIG. 5 is a graphical representation of resulting optical loss as a function of actuation voltage for the prior art VOA of FIG. 3, where the prior art VOA operation is based on electrostatic actuation.

FIG. 6 is a graphical representation of the total tilt of the reflective surface with respect to the collimating and focusing system, orθ, of the preferred embodiment of the present invention of FIG. 1B, as a function of actuation tilt for a VOA of the preferred embodiment of the present invention of FIG. 1B, where the reflecting surface has an initial tilt offset at zero actuation.

FIG. 7 is a graphical representation of the resulting optical loss as a function of actuation voltage for the electrostatically actuated VOA of FIG. 1B with initial tilt offset.

FIG. 8 is a graphical representation of the comparison of sensitivity of optical loss to fluctuations in actuation voltage as a function of optical loss setpoint for a prior art electrostatic VOA, i.e. without an initial, zero actuation tilt offset, and an electrostatic VOA of the current invention with an initial, zero actuation tilt offset.

### DETAILED DESCRIPTION OF THE PREFERRED EMBODIMENT

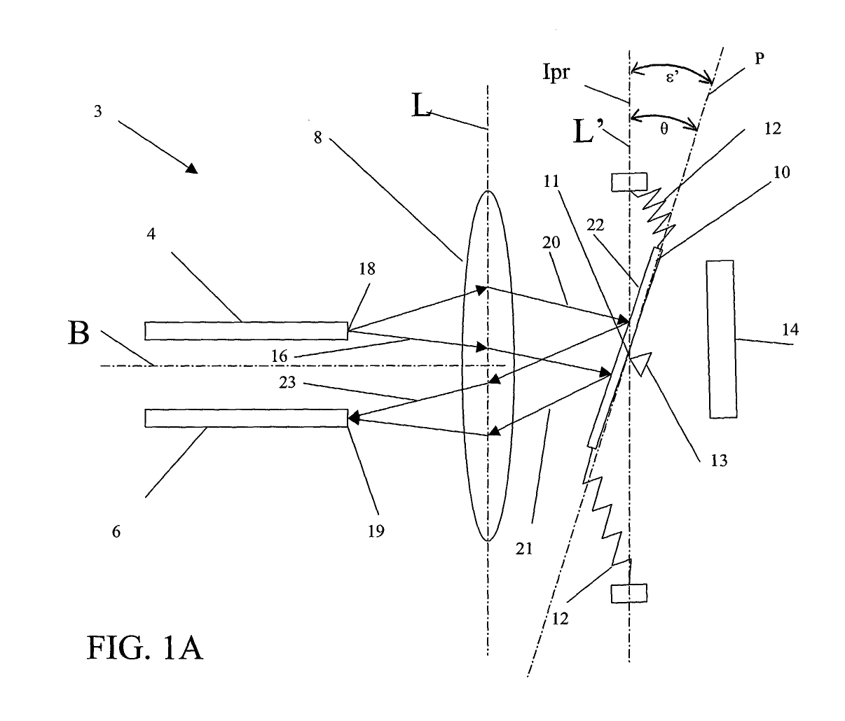

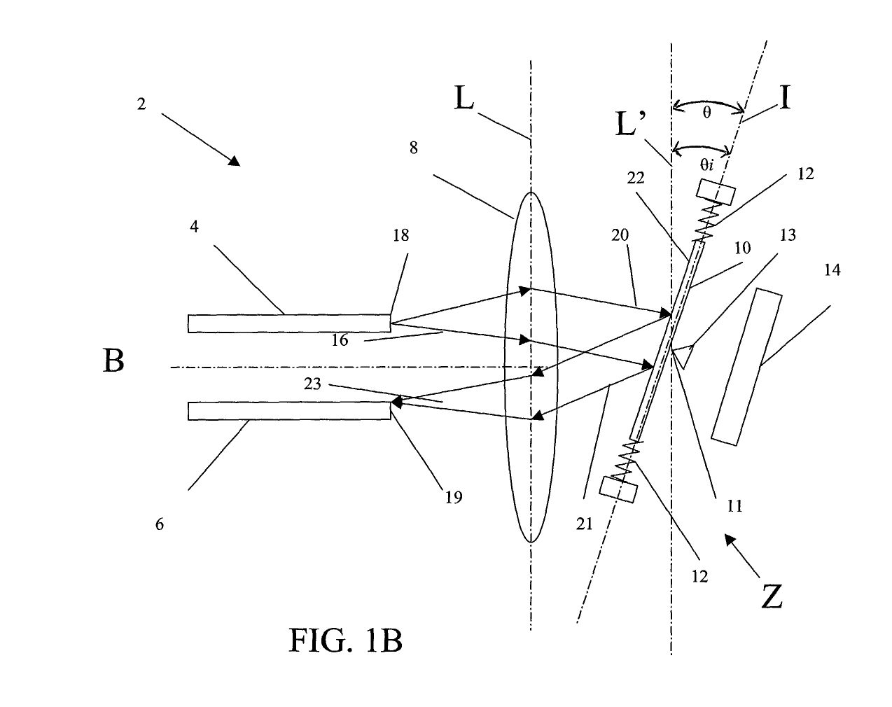

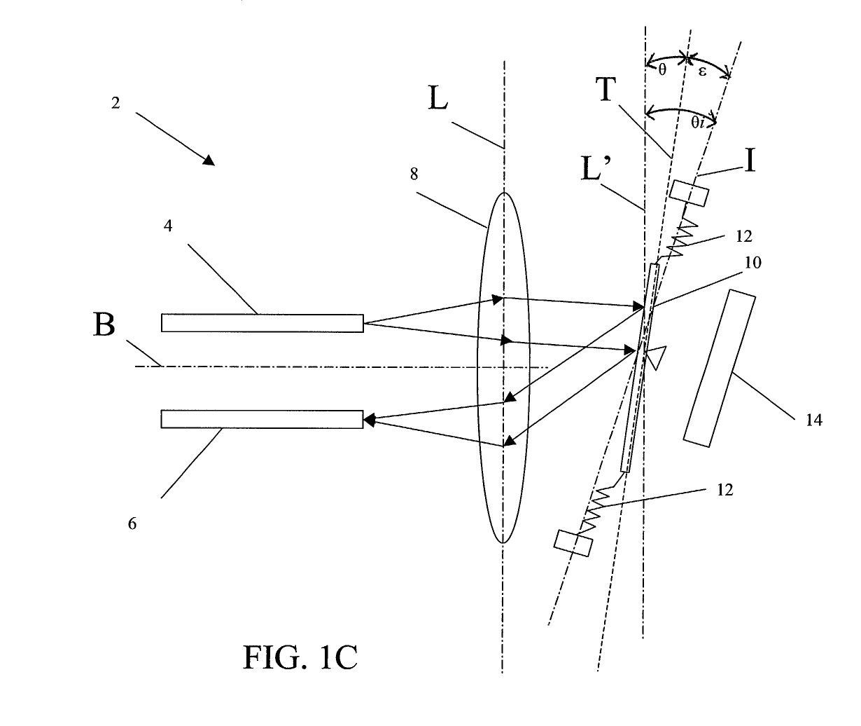

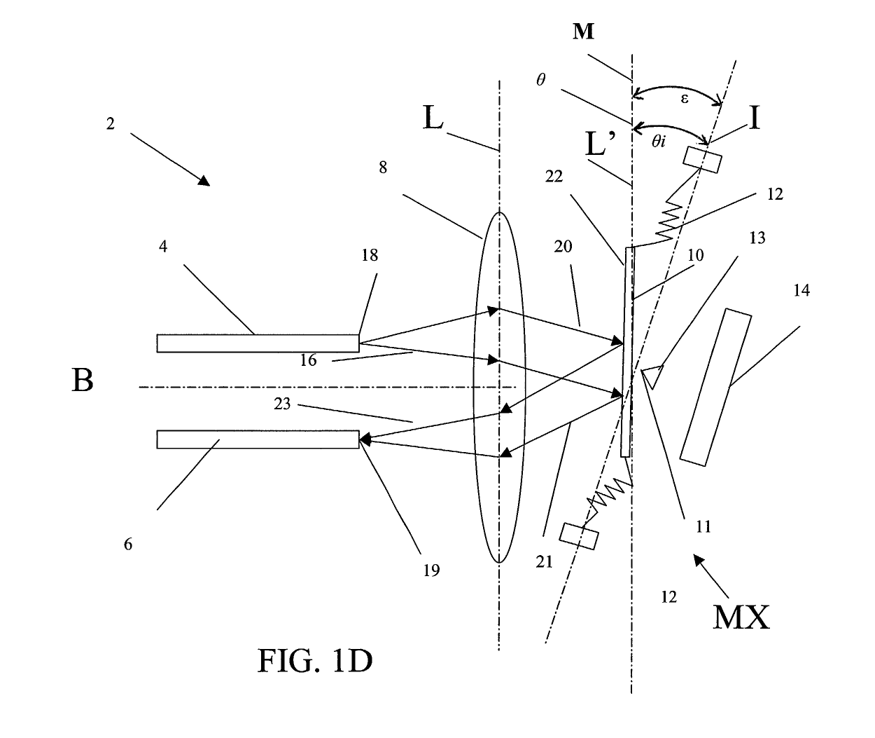

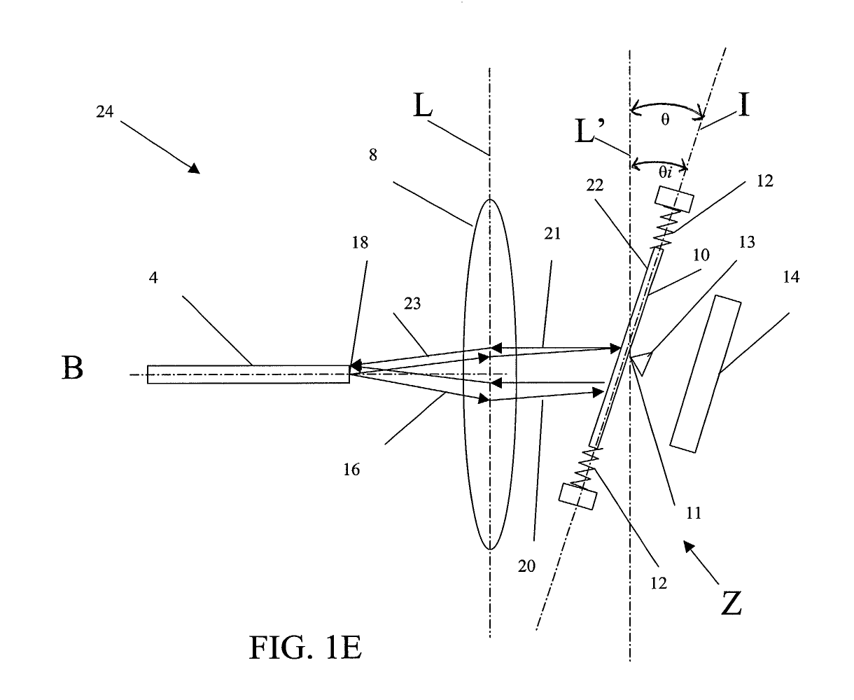

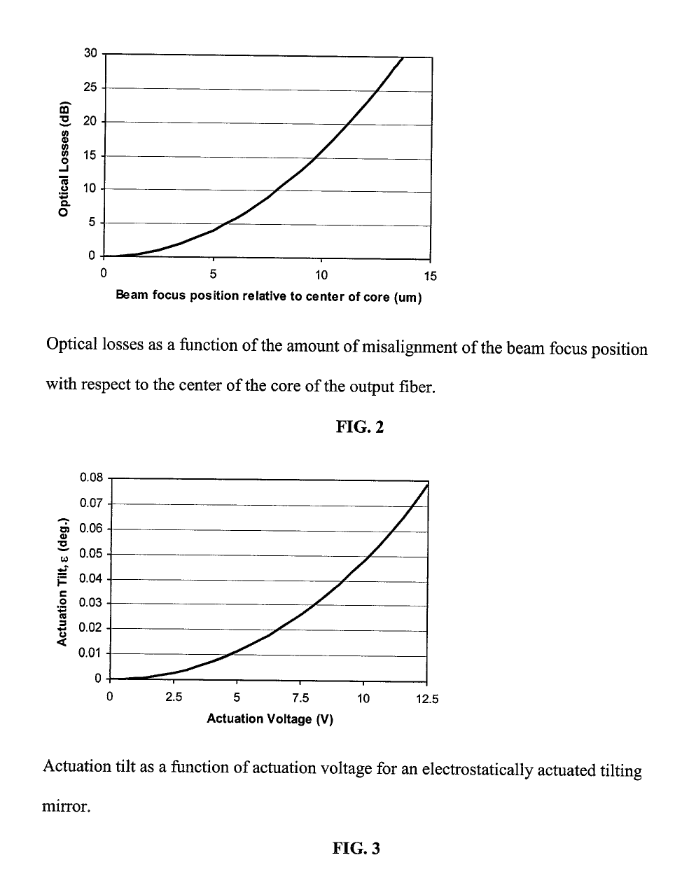

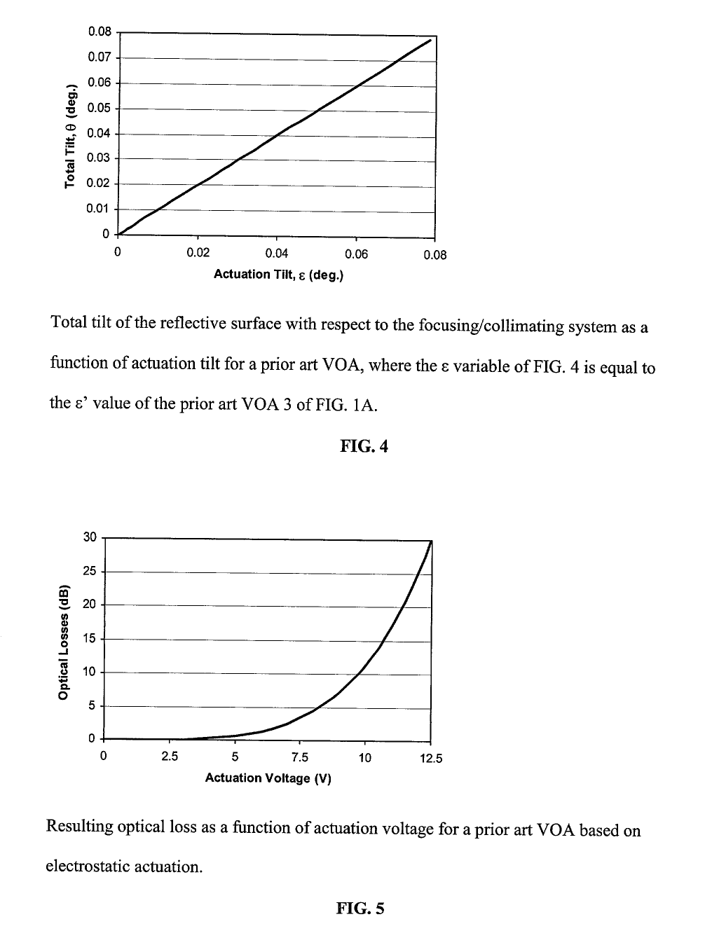

While the description above provides a full and complete disclosure of the preferred embodiments of the present invention, various modifications, alternate constructions, and equivalents will be obvious to those with skill in the art. Thus the scope of the present invention is limited solely by the appended claims. It is understood that specific parametric values of the preferred embodiment 2 of FIG. 1B, such as the values of initial θ, or θi, a pre-set maximal loss at θi, and the relationship of optical loss sensitivity to actuation signal voltage, may be selected in any particular alternate preferred embodiment according to a set of specifications, design requirements, performance requirements, manufacturing capabilities and technical capabilities of a VOA designer, user or manufacturer.

Referring generally to the Figures, and particularly to FIGS.' 1A and 1B, a preferred embodiment of the method of the present invention, or invented VOA 2, of FIG. 1B is contrasted with a prior art VOA 3 of FIG. 1B. Both the invented VOA 2 and the prior art VOA 3 have a light beam emitting optical waveguide 4, an output optical waveguide 6, a lens 8, a mirror 10, an optional mirror pivot point 11, a mechanical suspension element 12, an optional pivot 13 and an electrostatic actuator 14. The prior art VOA 3 has a zero actuation position where the initial θ is equal to zero, or approximately zero, and the mirror 10 is substantially parallel to the plane L, where plan L is perpendicular to an optical axis B of the lens 8. The mechanical suspension element 12 of the prior art VOA is a restoring element and provides a restoring force to the prior art VOA 3. The element 12 is operatively coupled with the mirror 10 to pull the mirror back to the prior art zero actuation position where θ equals zero. The actuator 14 of the prior art VOA 3 is operatively coupled to the mirror 10 and provides force to overcome the mechanical suspension element 12, whereby the angle θ is increased from a zero actuation value of zero or near zero to a value ε′, i.e. the θ angle of the prior art VOA 3 is equal to the angular displacement ε′ of the mirror 10 caused by the actuator 14.

Referring now to FIG. IA, the prior art VOA 3 maintains the mirror 3 in a plane Ipr, where θ equals zero, when the actuator provides zero force, or less than a minimal amount of force, to move the mirror 10. The plane Ipr is parallel to the planes L and L′. FIG. 1A shows the mirror 10 with an angular displacement of ε′ and positioned within a plane P.

Referring now to FIG. 1B, in the exemplary invented VOA 2 of FIG. 1B, the θ value is determined by subtracting a value of ε, where ε is an angular displacement mirror 10 caused by the actuator 14, from an initial θ, or θi. In the invented VOA 2 the value of θ is equal to θi minus e. The mechanical suspension element 12 of the invented VOA 2 is a restoring element 12 and provides a restoring force to the invented VOA 2. The restoring element 12 is operatively coupled with the mirror 10 to pull the mirror back to the prior art zero actuation position where θ equals θi. The actuator 14 of the invented VOA 2 is operatively coupled to the mirror 10 provides force to overcome the mechanical suspension element 12, whereby the angle θ is decreased from a zero actuation value of θi to a value of zero degrees, i.e. the θ angle of the invented VOA 2 is equal to the initial of θ angle, or θi minus ε, where ε is defined as an angular displacement of the mirror 10 caused by the actuator 14. The restoring element 12, of various alternate preferred embodiments of the method of the present invention, may comprise a mechanical element, a magnetic element, an electrical component, or another suitable restoring force provider known in the art. When the actuator 14 supplies no actuating force to the mirror 10, or a force below a certain minimal magnitude, the value of ε is zero. When ε is zero the value of θ is equal to θi, and the mirror 10 resides in the zero actuation position.

Referring now generally to Figures and particularly to FIG. 1B, the mirror is positioned at the initial zero actuation tilt offset of θi, at a pre-established zero actuation position Z. The θi angle of the exemplary invented VOA 2 is 0.078 degrees, although the value of θi varies, as do other constants mentioned herein, across a wide spectrum of values in various alternate preferred embodiments of the method of the present invention.. The exemplary invented VOA 2 thereby imposes a stipulated 30 dB maximum attenuation on a light beam 16 emitted by the emitting optical waveguide 4 and transmitted within the VOA 2, and to the output optical waveguide 6, or output waveguide 6 when the mirror 10 is at the zero actuation position Z. The light beam 16 is emitted from an emitting end-face 18 of the emitting optical waveguide 4, or emitting waveguide 4, and towards an output end-face 19 of the output waveguide 6. The emitting waveguide 4 and the output waveguide 6 may be or comprise an optical fiber. The mirror 10 may optionally positioned by pivoting. The pivot position and pivot angle of the mirror, or θ, is controlled by an electrostatic force delivered from the electrostatic actuator 14, or actuator 14, and to the mirror 10. The actuator 14 moves the mirror 10 by applying an electrostatic force against the mirror 10. The force applied by the actuator 14 to the mirror 10 increases in a linear relation to a magnitude of an input voltage that is applied to the actuator 14. It is understood that the angle θ is defined as the angle formed by the extrapolated geometric intersection of a plane L and a mirror plane T, T′&M. Plane L is perpendicular to an optical axis B of the focusing lens and plane M being parallel to the reflecting surface of the mirror, and noting that plane M and the angle θ vary as the mirror or reflecting moves in reference to the lens. Plane L′ is parallel to plane L and is provided to more clearly illustrate the angle between the mirror angles T, T′&M.

The lens 8 may be selected from the group consisting of a lens, an optical lens, a variable focus lens, a system of lenses and a GRIN lens in various alternate preferred embodiments of the present invention.

In one exemplary preferred embodiment of the preferred embodiment, the invented VOA 2 is a MEMS device and is integrated on a single substrate. The mirror 10 is a MEMS mirror and presents a 0.078 degree of angle, or angle θ, at 12.5 V. The restoring element 12 comprises a spring element 12 and tends to hold the mirror 10 in the zero actuation position Z and returns the mirror 10 to the zero actuation position Z when the force delivered by the actuator 14 falls to zero or below a minimal level. In the preferred embodiment 2 of FIG. 1B, the lens 8 has a focal distance of 5 mm. The lens 8 collimates light beam 16 passing from the emitting waveguide 4 to the mirror into a light beam 20. In addition, the lens 8 focuses the light beam 20 passing from the mirror and towards the output waveguide 6. The initial misalignment tilt of the mirror in the zero actuation position Z, or initial θ is 0.078 degrees, which corresponds to 30 dB attenuation of the light beam 16 as transmitted through the VOA 2 and to the output waveguide 6. The zero final tilt that presents a 0 dB attenuation of the light beam 20 is achieved at 12.5 V as applied to the actuator 14. The light beam 16 is emitted from the emitting waveguide 4 and is collimated into the light beam 20 by the lens 8. The collimated light beam 20 then reflects to form a reflected collimated light beam 21, after reflecting from the reflecting surface 22 of the mirror 10. The reflected collimated light beam 21 then passes through the lens 8. The lens 8 then focuses a focused, reflected and collimated light beam 23 towards the endface 19 of the output waveguide 6.

In an alternate preferred method of the present invention the emitting waveguide 4, or an equivalent light beam channel, and the lens 4 or element are positioned such that the light beam 16 does not pass through the lens 8 or element en route to the reflecting surface 22. The light beam 16 is therefore not collimated by the lens 8 or element before the light beam 16 strikes the reflecting surface 22. The light beam 16 reflects into the lens 8 by reflection off of the reflecting surface 22. The light beam 16 is then focused by the lens 8 or element 8 towards the output waveguide 6.

Referring generally to the Figures, and particularly to FIG. 1C, the mirror 10 of FIG. 1B is placed in a position of attenuation where the light beam 20 as transmitted from the emitting waveguide 4 and to the output waveguide 6. The mirror 10 has passed through the range of angular motion ε from the zero actuation position where θ was equal to θi of FIG. 1B. The mirror plane is at the plane T. The mirror 10 of the invented VOA 2 and may be positioned within the range of motion ε in an analog relationship with the magnitude of the voltage applied to the actuator 14. The VOA 2 may therefore selectably position the mirror 10 within the continuous range of motion ε. Selection of the tilt angle θ of the mirror 10 is therefore enabled at any point found within the range of motion or movement ε, whereas the prior art limits the positions of the mirror tilt angle θ to a discrete set of positions.

Referring generally to the Figures, and particularly to FIG. 1D, the mirror 10 of FIG. 1B is placed in a position of minimum attenuation MX of the light beam 20 as transmitted from the emitting waveguide 4 and to the output waveguide 6. The mirror 10 may pass through the range of motion ε of FIG. 1C and may be positioned within the range of motion ε in an analog relationship with the magnitude of the voltage applied to the actuator 14. The VOA 2 may therefore selectably position the mirror 10 within the continuous range of motion ε. Selection of the tilt angle θ of the mirror 10 is therefore enabled at any point found within the range of motion ε, whereas the prior art limits the positions of the mirror tilt angle θ to a discrete set of positions.

Referring generally to the Figures, and particularly to FIG. 1E, an alternate embodiment of the present invention, or a single waveguide system 24, comprises the mirror 10 of FIG. 1B and reflects light beam 16 back into the emitting waveguide 4. The reflected and focused light beam 23 is originally emitted from and by the emitting waveguide 4.

Referring now generally to the Figures and particularly to FIG. 2, FIG. 2 describes the optical losses in dB, or attenuation behavior, of a VOA that comprises an output optical fiber as or within the output waveguide and controllably and dynamically misaligns the reflected light beam into the output fiber as an attenuation method. FIG. 2 is a graphical representation of optical losses of a transmission of a light beam within the VOA as a function of the amount of misalignment, or ΔX of the light beam focus position with respect to the center of the core of the output fiber. As the ΔX distance increases the optical loss increases in a non-linear relationship.

Referring now generally to the Figures and particularly to FIG. 3., FIG. 3 describes the actuation tilt, or ε, imposed on the mirror of a VOA by an electrostatic actuator. As the actuation signal, or actuation control voltage, increases, the tilt imposed on the mirror increases in a non-linear relationship..

Referring now generally to the Figures and particularly to FIG. 4., the behavior of the prior art VOA is expressed. The value of the tilt angle between the reflecting surface and the lens, or θ, as the actuator imposed tilt angle, or ε, is varied by the prior art VOA is presented. FIG. 4 is a graphical representation of the total tilt, or θ, of the reflective surface with respect to a collimating and focusing lens, or element, as a function of actuation tilt for the prior art VOA, where the initial θ is zero or approximately zero.

Referring now generally to the Figures and particularly to FIG. 5, FIG. 5 is a graphical representation of resulting optical loss as a function of actuation voltage for the prior art VOA of FIG. 4, where the tilting of the prior art VOA mirror is effected by electrostatic actuation and as described in FIGS.' 2 and 3. The resulting relationship in the prior art VOA of the responsiveness of optical loss to actuation voltage is a consequence of placing the prior art mirror at an initial θ of zero or near zero, and thereby forming the behavior of optical loss versus actuation voltage on the basis of the two non-linear dynamics optical loss versus Δ, as per FIG. 2, and the non-linear relationship of actuation voltage versus both θ and ε of FIGS.' 3 and 4. The combination of the relationships described in FIGS.' 2, 3 and 4 cause the prior art to evidence a highly non-linear relationship between actuation voltage and optical loss, as shown in FIG. 5.

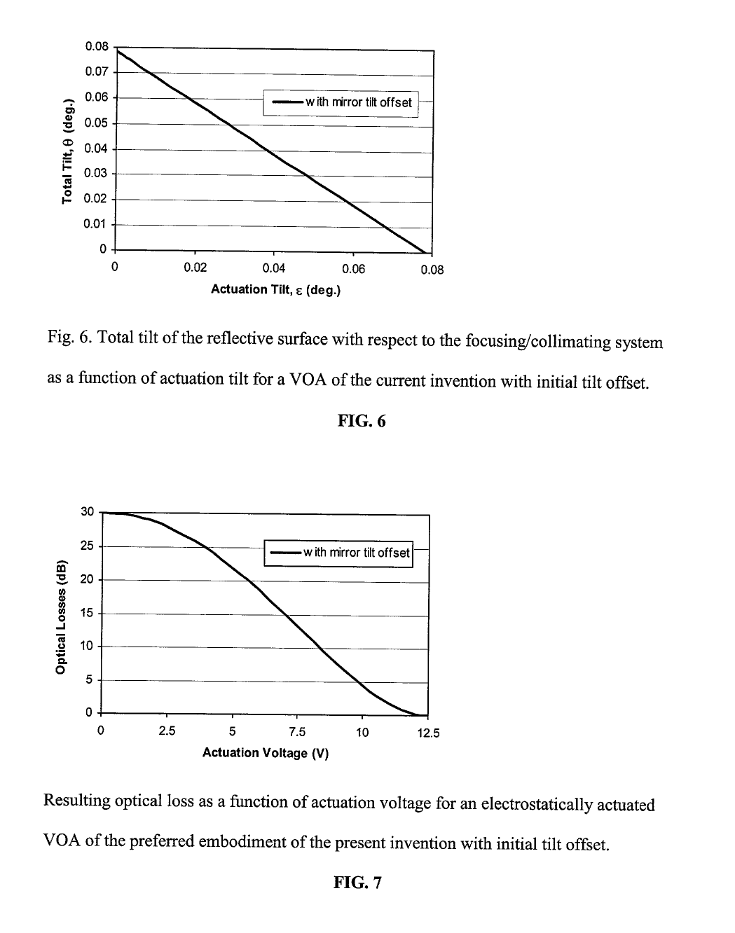

Referring now generally to the Figures and particularly to FIG. 6, FIG. 6 is a graphical representation of the total tilt of the reflective surface 22 with respect to the collimating and focusing lens 8, or θ, of the preferred embodiment of the present invention 2 of FIG. 1B, as a function of actuation tilt for a VOA having an initial tilt offset, or initial θ of 0.078 degrees at zero actuation. FIG. 6 shows that the mirror tilt, or angle θ decreases linearly from the initial θ of 0.078 degrees as the actuation angle ε increases. Furthermore, the angle θ approaches zero, where a minimum attenuation is achieved by the invented VOA of FIG. 1B, as ε approaches 0.078 degrees.

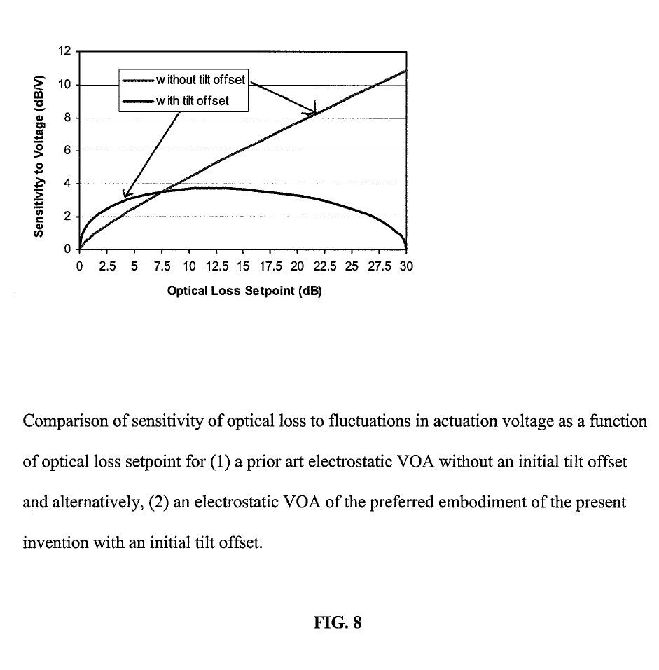

Referring now generally to the Figures and particularly to FIG. 7, FIG. 7 is a graphical representation of the resulting optical loss as a function of actuation voltage for the electrostatically actuated invented VOA of FIG. 1B with initial tilt offset of 0.078 degrees. The characteristic of the relationship of actuation voltage and optical loss value is made more linear than the prior art by the method of the present invention wherein the increase in actuation signal voltage input into the actuator 14 causes the value of ε to linearly increase. As expressed in FIG. 6, as the value of ε increases in the invented VOA 2, the value of the tilt angle θ decreases linearly. As the relationship between the tilt angle of θ and ΔX is linear for small changes in θ, the relationship between optical loss and actuation signal voltage can be approximately derived from the relationships as expressed in FIG. 7 and is approximated in the operation of the invented VOA 2 by inference from (1) the non-linear relationship between ΔX and optical loss of FIG. 2, (2) the linear relationship between the actuation tilt and total tilt of the invented system, as per FIG. 6, and (3) the nonlinear relationship between actuation voltage of the electrostatically actuated tilted mirror of FIG. 1B, as expressed in FIG. 3. The resulting relationship of the invented VOA 2 between actuation signal voltage and optical loss magnitude is thereby formed as having a more linear correspondence than the relationship between actuation signal voltage and optical loss magnitude of the prior art.

Referring now generally to the Figures and particularly to FIG. 8, FIG. 8 is a comparison of sensitivity of optical loss to actuation voltage, in dB per Volt, along the (vertical axis) versus optical loss setpoint (horizontal axis) for (1) a prior art electrostatic VOA without an initial tilt offset and alternatively, (2) an electrostatic VOA of the preferred embodiment of the present invention with an initial tilt offset. The maximum optical loss sensitivity to actuation voltage fluctuations is significantly reduced by using the linearization method of the present invention. FIG. 8 shows that the preferred embodiment of FIG. 1B has a maximum sensitivity to actuation voltage of less than 4 dB/V, whereas the prior art maximum approaches 11 dB/V at 30 dB.

A quantitative comparison between the linearized method of the present invention versus prior art method is made by comparing the sensitivity of the optical attenuation to fluctuations in actuation voltages for both the prior art VOA and the invented VOA 2. In a real application, the VOA optical attenuation resolution will be limited by noise and control uncertainty in the actuation. It is desirable to have minimum optical loss fluctuations, i.e. low actuation sensitivity. This actuation sensitivity is calculated from the slope of the transduction curves of FIG. 5 for the prior art and FIG. 7 of the preferred embodiment of the present invention, respectively. The results are shown in FIG. 8. The results were calculated from the slope of the transduction curves in FIGS.' 5 and 7, with the optical attenuation set point as the variable.

In the initial assembly of the VOA 2, the mirror 10 is intentionally misaligned angularly with respect to the lens 8, such as to obtain a non-zero tilt at zero actuation Z. This results in non-zero optical losses of the VOA 2 at zero actuation. Specifically, the mirror 10 is misaligned exactly such that the obtained loss at zero actuation equals the maximum required loss according to the specification of the VOA 2, e.g. 30 dB for the example discussed here. Then, the actuation of the mirror 10 is directed such that the mirror will tilt closer toward perfect alignment with the lens 8, rather than away from perfect alignment in prior art mirror based VOA's. At minimum attenuation, the mirror 10 tilt with respect to the lens 8 returns to zero, i.e. the minimum optical loss position of the VOA.

This preferred embodiment of the method of the present invention of FIG. 1B results in a linearization of the VOA optical attenuation versus actuation power transduction curve because the two relationships depicted in 6 FIGS.' 2 and 3 are not combined in a multiplicative manner but rather in a compensating and linearizing manner. In contrast, using the same transduction curves as in FIGS.' 2 and 3, for the example of the electrostatically actuated mirror, but combining them in a prior art fashion, the resulting transduction curve of the prior art is more highly linearized, as shown in FIG. 5.

The invention has been described in conjunction with the preferred embodiment. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

We claim:

1. A variable optical attenuator, comprising:
a lens,
a first optical waveguide;
a second optical waveguide, the second waveguide positioned to receive light beam from the lens;
a semiconductor micro-electro-mechanical device, the device having a reflecting surface and an actuator;
the reflecting surface positioned for reflecting a light beam emitted from the first optical waveguide, through the lens and into the second optical waveguide; and
the actuator for controllably moving the reflecting surface from a zero actuation position through a range of motion to a minimum attenuation position, the zero actuation position for attenuating a transmission from the first optical waveguide to the second optical waveguide at a preset maximum attenuation level, and wherein the device returns the reflecting surface to the zero actuation position when the actuator receives less than a minimal amount of power.

2. The apparatus of claim 1, further comprising a restoring element, wherein the restoring element provides force to cause the reflecting surface to return to the zero actuation position when the actuator receives less than the minimal amount of power.

3. The apparatus of claim 1, wherein the actuator wherein the actuator is selected from the group consisting of an electro-static actuator, a piezo-electric actuator, a thermo-mechanical actuator, an electromagnetic actuator, and a polymer actuator.

4. The apparatus of claim 3, wherein the polymer actuator is selected from the group consisting of an electro-active polymer actuator, an optical-active polymer, a chemically active polymer actuator, a magneto-active polymer actuator, an acousto-active polymer actuator and a thermally active polymer actuator.

5. The apparatus of claim 1, wherein the actuator moves the reflecting surface rotatably about an axis.

6. The apparatus of claim 1, wherein the optical waveguides each further comprise at least one optical fiber each.

7. The apparatus of claim 1, wherein the second optical waveguide comprises an optical fiber.

8. A method for controllably attenuating the transmission of a beam of light in a more linear relationship between applied power and decreased attenuation, comprising:
a. providing a first optical waveguide, a second optical waveguide, a lens, and a semiconductor micro-electro-mechanical system, the system having a reflecting surface and an actuator;
b. the first optical waveguide for emitting a light beam towards the reflecting surface of the device;
c. the reflecting surface for reflecting the light beam, as received from the first optical waveguide, through lens and into the second waveguide;
d. the actuator for moving the reflecting surface from a zero actuation position through a range of motion to a minimum attenuation position, and wherein a pre-selected maximum attenuation of a transmission of the light beam from the first optical waveguide to the second optical waveguide is achieved when the reflecting surface is placed in the zero actuation position;
e. placing the reflecting surface in the zero actuation position;
f. providing power to the actuator and causing the actuator to move the reflecting surface and reducing the potential attenuation of the transmission of the light beam; and
g. emitting light from the first optical waveguide, whereby the light beam is transmitted through lens and into the second optical waveguide.

9. The method of claim 8, further comprising a provision of a restoring element, the restoring element operatively coupled with the reflecting surface, and the restoring element providing force to return the reflecting surface to the zero actuation position when the actuator is providing less than a minimal amount of force to the system.

10. The method of claim 8, further comprising a positioning of the lens to facilitate the transmission of the light beam from the first optical waveguide to the reflecting surface.

11. The method of claim 1, wherein the reflecting mirror returns to the zero actuation position when the actuator delivers less than a minimal amount of force to the reflecting surface.

12. A variable optical attenuator, comprising:
a light channel, the light channel emitting a light beam;
a movable mirror having a reflecting surface, the reflecting surface for reflecting the light beam;
a collimating and focusing element, the element positioned to collimate the light beam into a collimated light beam as the light beam transmits from the light channel to the mirror, and the element positioned to focus the collimated light beam towards an output waveguide after reflection from the reflecting surface;
the output waveguide statically positioned relative to the collimating and focusing element to transmit the light beam reflected from the reflecting surface, the output waveguide for transmitting a portion of the reflected light beam out of the variable optical attenuator, wherein the magnitude of the portion of the reflected light beam transmitted by the output waveguide is substantially determined by a position of the reflecting surface; and
the reflecting surface having an angular range of motion from a zero actuation position to a minimum attenuation position, the zero actuation position providing approximately a predetermined attenuation of transmission of the light beam as reflected into the output waveguide, whereby attenuation of the light beam reflected into the output waveguide is more linearly controllable as the reflecting surface moves from the zero actuation position and to the minimum attenuation position.

13. The apparatus of claim 12, wherein the apparatus further comprises an actuator, the actuator operatively connected to the mirror and causing the reflecting surface to angularly move from the zero actuation position and towards the minimum attenuation position in a non-linear relationship with a control signal value received by the actuator.

14. The apparatus of claim 12, wherein the light channel is positioned to transmit the light beam through the collimating element en route to the reflecting surface, whereby the light beam is collimated prior to striking the reflecting surface before reflecting.

15. The apparatus of claim 12, wherein the collimating and focusing element is selected from the group consisting of a lens, an optical lens, a variable focus lens, a system of lenses and a GRIN lens.

16. The apparatus of claim 12, wherein the light channel is an optical waveguide.

17. The apparatus of claim 12, wherein the light channel is an optical fiber.

18. The apparatus of claim 12, wherein the output waveguide is an optical fiber.

19. The apparatus of claim 18, wherein the light channel is an optical fiber.

20. The apparatus of claim 12, further comprising a restoring element, wherein the restoring element provides a force to cause the reflecting surface to return to the zero actuation position when the actuator receives less than a minimal control signal value.

21. The apparatus of claim 13, wherein the actuator is selected from the group consisting of an electro-static actuator, a piezo-electric actuator, a thermo-mechanical actuator, an electromagnetic actuator, and a polymer actuator.

22. The apparatus of claim 21, wherein the polymer actuator is selected from the group consisting of an electro-active polymer actuator, an optical-active polymer, a chemically active polymer actuator, a magneto-active polymer actuator, an acousto-active polymer actuator and a thermally active polymer actuator.

23. The apparatus of claim 13, wherein the actuator comprises at least two members selected from the group consisting of an electro-static actuator, a piezo-electric actuator, a thermo-mechanical actuator, an electromagnetic actuator, and a polymer actuator, whereby the reflecting surface is operatively coupled to at least two members.

24. The apparatus of claim 13, wherein the actuator moves the reflecting surface rotatably about an axis.

25. The apparatus of claim 17, wherein the output waveguide comprises at least one optical fiber.

26. The apparatus of claim 12, wherein the apparatus is a MEMS device.

27. A method for controllably attenuating the transmission of a beam of light in a more linear relationship between an actuation signal and decreased attenuation, comprising:
a. providing an apparatus having a light beam channel, an output waveguide, a collimating and focusing element, and a mirror, the mirror having a reflecting surface;
b. the light beam channel for emitting a light beam towards the reflecting surface of the mirror and through the collimating and focusing element;
c. the collimating and focusing element for collimating the light beam into a light beam as the light beam transmits from the light beam channel to the reflecting surface, and the collimating and focusing element for focusing the light beam towards the output wave guide as the light beam transmits from the reflecting surface of the mirror and towards the output waveguide;
d. the reflecting surface for reflecting the light beam towards the collimating and focusing element;
e. the reflecting surface having an angular range of motion from a zero actuation position to a minimum attenuation position, and wherein a pre-selected maximum attenuation of a transmission of the light beam from the light beam channel to the output waveguide is achieved when the reflecting surface is placed in the zero actuation position;
f. placing the reflecting surface in the zero actuation position;
g. emitting light beam from the light beam channel;
h. collimating the light beam into a light beam within the collimating and focusing element;
i. transmitting the collimated light beam to the reflecting surface;
j. reflecting the light beam from the reflecting surface and through the collimating and focusing element;
k. focusing the light beam from the collimating and focusing lens and into the output waveguide, whereby the light beam is attenuated and transmitted into the output optical waveguide; and
l. reducing the attenuation of the transmission of the light beam by moving the reflecting surface away from the zero actuation position and towards the minimum attenuation position, whereby the attenuation of the light beam received by the output waveguide is attenuated in a more linear relationship to the angular movement of the reflecting surface.

28. The method of claim 27, wherein the apparatus further comprises an actuator, the actuator operatively connected to the mirror and causing the reflecting surface to angularly move from the zero actuation position and towards the minimum attenuation position in non-linear linear relationship with a control signal.

29. The method of claim 27, wherein the collimating and focusing element is selected from the group including a lens, an optical lens, a variable focus lens, a lens system and a GRIN lens.

30. The method of claim 27, wherein the light beam channel is a waveguide.

31. The method of claim 27, wherein the light beam channel is an optical fiber.

32. The method of claim 27, wherein the output waveguide is an optical fiber.

33. The method of claim 32, wherein the light beam channel is an optical fiber.

34. The method of claim 28, further comprising a restoring element, wherein the restoring element provides a force to cause the reflecting surface to return to the zero actuation position when the actuator receives less than a minimal control signal value.

35. The method of claim 28, wherein the actuator is selected from the group consisting of an electro-static actuator, a piezo-electric actuator, a thermo-mechanical actuator, an electromagnetic actuator, and a polymer actuator.

36. The method of claim 35, wherein the polymer actuator is selected from the group consisting of an electro-active polymer actuator, an optical-active polymer actuator, a chemically active polymer actuator, a magneto-active polymer actuator, an acousto-active polymer actuator and a thermally active polymer actuator.

37. The method of claim 28, wherein the actuator comprises at least two members selected from the group consisting of an electro-static actuator, a piezo-electric actuator, a thermo-mechanical actuator, an electromagnetic actuator, and a polymer actuator, whereby the reflecting surface is operatively coupled to at least two members.

38. The method of claim 28, wherein the actuator moves the reflecting surface rotatably about an axis.

39. The method of claim 30, wherein the optical waveguides each further comprise at least one optical fiber each.

40. A variable optical attenuator, comprising:
a light beam emitting waveguide, the light beam emitting waveguide for emitting a light beam;
a movable mirror having a reflecting surface, the reflecting surface for reflecting the light beam;
a collimating and focusing element, the element positioned to collimate the light beam into a light beam as the light beam transmits from the light channel to the mirror, and the element positioned to focus the light beam back towards the light beam emitting waveguide after reflection of the light beam from the reflecting surface;
the light beam emitting waveguide statically positioned relative to the collimating and focusing element to transmit light beam reflected from the reflecting surface;
the light beam emitting waveguide for transmitting a portion of the reflected light beam out of the variable optical attenuator, wherein the magnitude of the portion of the reflected light beam transmitted out of the variable optical attenuator by the light beam emitting waveguide is substantially determined by a position of the reflecting surface; and
the reflecting surface having an angular range of motion from a zero actuation position to a minimum attenuation position, the zero actuation position providing approximately a pre-determined attenuation of transmission of the light beam as reflected into the output waveguide, whereby attenuation of the light beam reflected into the output waveguide is more linearly controllable as the reflecting surface angularly moves from the zero actuation position and to the minimum attenuation position.

41. The apparatus of claim 40, wherein the apparatus further comprises an actuator, the actuator operatively connected to the mirror and causing the reflecting surface to angularly move from the zero actuation position and towards the minimum attenuation position in a non-linear relationship with an actuation signal value received by the actuator.

42. The apparatus of claim 40, wherein the collimating and focusing element is selected from the group consisting of a lens, a variable focus lens, an optical lens, a system of lenses and a GRIN lens.

43. The apparatus of claim 40, wherein the light beam emitting waveguide is a light emitting optical fiber.

44. The apparatus of claim 40, further comprising a restoring element, wherein the restoring element provides a force to cause the reflecting surface to return to the zero actuation position when the actuator receives less than a minimal control signal value.

44. The apparatus of claim 41, wherein the actuator is selected from the group consisting of an electro-static actuator, a piezo-electric actuator, a thermo-mechanical actuator, an electromagnetic actuator, and a polymer actuator.

45. The apparatus of claim 44, wherein the polymer actuator is selected from the group consisting of an electro-active polymer actuator, an optical-active polymer, a chemically active polymer actuator, a magneto-active polymer actuator, an acousto-active polymer actuator and a thermally active polymer actuator.

46. The apparatus of claim 41, wherein the actuator comprises at least two members selected from the group consisting of an electro-static actuator, a piezo-electric actuator, a thermo-mechanical actuator, an electromagnetic actuator, and a polymer actuator, whereby the reflecting surface is operatively coupled to at least two members.

47. The apparatus of claim 41, wherein the actuator moves the reflecting surface rotatably about an axis.

48. The apparatus of claim 42, wherein the light beam emitting comprises at least two optical fibers

49. The apparatus of claim 42, wherein the apparatus is a MEMS device.

50. A method for controllably attenuating the transmission of a beam of light in a more linear relationship between actuation and decreased attenuation, comprising:
a. providing an apparatus having a light beam emitting waveguide, a collimating and focusing element, and a mirror, the mirror having a reflecting surface;
b. the light beam emitting waveguide for emitting a light beam towards the reflecting surface of the mirror and through the collimating and focusing element;
c. the collimating and focusing element for collimating the light beam into a light beam as the light beam transmits from the light beam emitting waveguide to the reflecting surface, and the collimating and focusing element for focusing the light beam back towards the light beam emitting waveguide as the light beam transmits from the reflecting surface of the mirror and towards the light beam emitting waveguide;
d. the reflecting surface for reflecting the light beam through the collimating element and back into the light beam emitting waveguide;
e. the reflecting surface having a range of angular motion from a zero actuation to a minimum attenuation position, and wherein a pre-selected maximum attenuation of a transmission of the light beam from the light beam emitting waveguide and back into the light beam emitting waveguide is achieved when the reflecting surface is placed in the zero actuation position;
f. placing the reflecting surface in the zero actuation position;
g. emitting light beam from the light beam emitting waveguide;
h. collimating the light beam into a light beam within the collimating and focusing element;
i. transmitting the collimated light beam to the reflecting surface;
j. reflecting the light beam from the reflecting surface and through the collimating and focusing element;
k. focusing the light beam from the collimating and focusing lens and into the light beam emitting waveguide, whereby the light beam is attenuated and transmitted through the collimating element and into the light beam emitting waveguide; and
l. reducing the attenuation of the transmission of the light beam by moving the reflecting surface from the zero actuation position and towards the minimum attenuation position, whereby the attenuation of the light beam reflected back into the light beam emitting waveguide is reduced in a more linear relationship to an angular movement of the reflecting surface.

51. The method of claim 50, the apparatus further comprising an actuator, wherein the actuator is operatively connected to the mirror and causes the reflecting surface to angularly move from the zero actuation position and towards the minimum attenuation position in an approximately linear relationship with a control signal value received by the actuator.

52. The method of claim 50, wherein the collimating and focusing element is selected from the group consisting of a lens, an optical lens, a variable focus lens, a system of lenses and a GRIN lens.

53. The method of claim 50, wherein the light beam emitting waveguide is an optical fiber.

54. The method of claim 51, further comprising a restoring element, wherein the restoring element provides a force to cause the reflecting surface to return to the zero actuation position when the actuator receives less than a minimal control signal value.

55. The method of claim 51, wherein the actuator is selected from the group consisting of an electro-static actuator, a piezo-electric actuator, a thermo-mechanical actuator, an electromagnetic actuator, and a polymer actuator.

56. The apparatus of claim 55, wherein the polymer actuator is selected from the group consisting of an electro-active polymer actuator, an optical-active polymer, a chemically active polymer actuator, a magneto-active polymer actuator, an acousto-active polymer actuator and a thermally active polymer actuator.

57. The apparatus of claim 51, wherein the actuator comprises at least two members selected from the group consisting of an electro-static actuator, a piezo-electric actuator, a thermo-mechanical actuator, an electromagnetic actuator, and a polymer actuator, whereby the reflecting surface is operatively coupled to at least two members.

59. The method of claim 51, wherein the actuator moves the reflecting surface rotatably about an axis.

60. The apparatus of claim 1, wherein the collimating and focusing element is selected from the group consisting of a lens, a variable focus lens, an optical lens, a system of lenses and a GRIN lens.

61. The apparatus of claim 40, wherein the apparatus is integrated on a single substrate.

62. The apparatus of claim 60, wherein the apparatus is incorporated as a MEMS device.
